(19) United States
(12) Patent Application Publication
(10) Pub. No.: US 2017/0122572 A1
(43) Pub. Date: May 4, 2017

(54) ROLLER, DEPLOYMENT SYSTEM, AND DOMESTIC COOKING APPLIANCE

(71) Applicant: BSH Hausgeräte GmbH, Munich (DE)

(72) Inventors: Alexander Dinkel, Unterwoessen (DE); Philipp Schaller, Traunreut (DE)

(21) Appl. No.: 15/318,368

(22) PCT Filed: Jun. 24, 2015
(86) PCT No.: PCT/EP2015/064206

§ 371 Date: Dec. 13, 2016

(30) Foreign Application Priority Data
Jul. 21, 2014 (DE) 10 2014 214 170.2

(51) Int. Cl. F24C 15/16; A47J 27/00; A47J 36/00

(52) U.S. Cl. CPC F24C 15/168; A47J 36/00; A47J 27/002

(57) ABSTRACT

A roller for a cooking item support system, in particular for a deployment system, of a domestic cooking appliance includes a roller body and an antifriction bearing which is accommodated at least partly in the roller body and is used for supporting the roller against or on a roller pin of the cooking item support system.

The present invention relates to a roller, a cooking item support system and a domestic cooking appliance.

For domestic cooking appliances such as for example ovens there are so-called cooking item support systems which enable the user to pull accessories such as baking trays significantly further out of the oven than would be possible with normal oven shelves.

DE 10 2008 010 501 A1 describes such a cooking item support system for a domestic cooking appliance. The cooking item support system has running rails which are guided on rollers.

Against this background, an object of the present invention consists in providing an improved roller.

Accordingly, a roller is proposed for a cooking item support system, in particular for a deployment system, of a domestic cooking appliance, comprising a roller body and an antifriction bearing which is accommodated at least partly in the roller body and is used for supporting the roller against or on a roller pin of the cooking item support system.

By virtue of the fact that the antifriction bearing is provided it is possible to dispense with a grease lubrication facility. By contrast, with regard to a bearing system provided with a grease lubrication facility the functionality of the roller would not be guaranteed over the service life of the cooking item support system in the case of frequent cleaning thereof in a dishwasher or with the aid of pyrolysis. Provision of the antifriction bearing means that the functionality of the cooking item support system is also always guaranteed when the cooking item support system is cleaned in a dishwasher. In particular, the roller body and the antifriction bearing are designed in two parts.

In accordance with an embodiment, the antifriction bearing is accommodated in a receiving section of the roller body.

The receiving section can be a hole completely penetrating the roller body. The antifriction bearing can be fitted, in particular loosely, into the receiving section.

In accordance with a further embodiment, the antifriction bearing is connected in non-positive manner to the receiving section.

The antifriction bearing can be pressed into the receiving section. An interference fit can be provided between the antifriction bearing and the receiving section.

In accordance with a further embodiment, the antifriction bearing is connected in positive manner to the receiving section.

By this means, the antifriction bearing can be prevented from rotating relative to the roller body. The antifriction bearing can also be connected to the receiving section in non-positive and positive manner In the case of a purely positive connection it is possible to dispense with a fit system between the antifriction bearing and the roller body, which fit system is highly precise and thus complex and costly to produce.

In accordance with a further embodiment, the antifriction bearing has an engagement section which engages in positive manner into a counter engagement section of the receiving section.

The engagement section can be a lateral flattening of the in particular tubular or cylindrical antifriction bearing. The counter engagement section is preferably designed corresponding to the lateral flattening of the antifriction bearing. Alternatively, the engagement section and the counter engagement section can form a tongue and groove connection. By this means, a coding is achieved and the possibility of incorrect fitting of the antifriction bearing is thereby excluded.

In accordance with a further embodiment, the antifriction bearing has two bearing elements which are separate from one another, and which are accommodated at opposing end sections of the receiving section in the latter.

The end sections of the receiving section preferably have a greater diameter than a section of the receiving section arranged between the end sections.

In accordance with a further embodiment, the roller body is made from a steel material or a ceramic material.

By this means, an adequate heat resistance is ensured, also during the pyrolysis cycle of the domestic cooking appliance.

In accordance with a further embodiment, the antifriction bearing is made from a sintered metal material, a ceramic material or a graphite material.

In particular, high-density sintered materials with solid lubricants included in a bronze or iron matrix are a possible material for the antifriction bearing. Said materials have a good chemical resistance and a very good temperature resistance. Furthermore, different ceramic materials having excellent tribological properties, such as zirconium oxide, silicon carbide or silicon nitride can be employed for the antifriction bearings. Alternatively, special graphite can be employed as the antifriction bearing material.

In accordance with a further embodiment, the roller body has a cylindrical, convex or concave running surface.

If the cooking item support system has tubular or rod-shaped running rails, concave running surfaces are preferably provided on the rollers. Alternatively, in the case of C-shaped running rails crowned or convex running surfaces can be provided on the roller bodies.

Furthermore, a cooking item support system, in particular a deployment system, is proposed for a domestic cooking appliance, having at least one such roller and at least one running rail, wherein the at least one roller is designed to roll on the least one running rail.

The deployment system can also be described as a telescopic deployment system. The running rails can also be described as guide rails.

In accordance with an embodiment, the cooking item support system has a roller pin, against or on which the at least one roller is rotatably mounted.

The roller pin can be made from steel or ceramic.

In accordance with a further embodiment, the roller pin is fastened to a support of the cooking item support system, wherein the support can be connected to a side wall of a cooking chamber of the domestic cooking appliance.

The support has in particular a fastening section. The cooking item support system can be connected to the side wall by means of the fastening section.

In accordance with a further embodiment, the cooking item support system can be removed from the cooking chamber.

The cooking item support system can preferably be removed from the cooking chamber without using tools. This means that the cooking item support system can be simply removed from the cooking chamber and for example cleaned in a dishwashing machine.

Furthermore, a domestic cooking appliance having such a roller and/or such a cooking item support system is proposed.

The domestic cooking appliance can be an oven, a microwave oven, an oven having a microwave function, a steam cooker or the like.

In accordance with an embodiment, two cooking item support systems are provided which are provided on opposing side walls of a cooking chamber of the domestic cooking appliance.

Further possible implementations of the roller, the cooking item support system and/or the domestic cooking appliance also comprise combinations not explicitly mentioned of features or embodiments described previously or in the following in respect of the exemplary embodiments. In this situation the person skilled in the art will also add individual aspects as enhancements or additions to the respective basic form of the roller, the cooking item support system and/or the domestic cooking appliance.

Further advantageous embodiments and aspects of the roller, the cooking item support system and/or the domestic cooking appliance are set down in the subclaims and also in the exemplary embodiments described in the following of the roller, the cooking item support system and/or the domestic cooking appliance. The roller, the cooking item support system and/or the domestic cooking appliance will be described in detail in the following with reference to the attached figures on the basis of preferred exemplary embodiments.

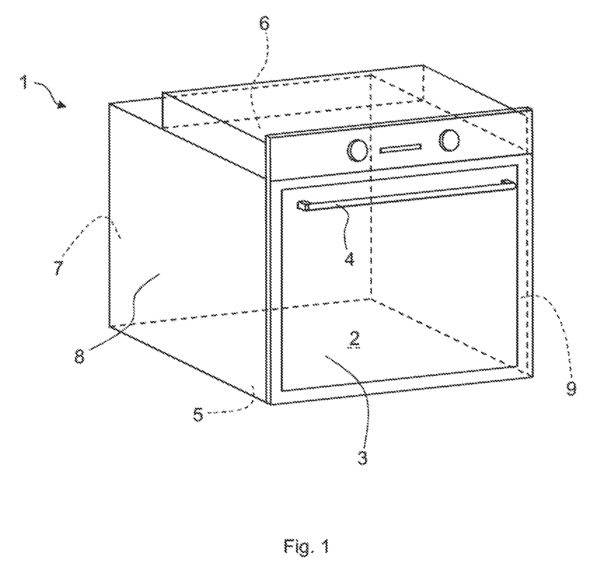

FIG. 1 shows a schematic perspective view of an embodiment of a domestic cooking appliance;

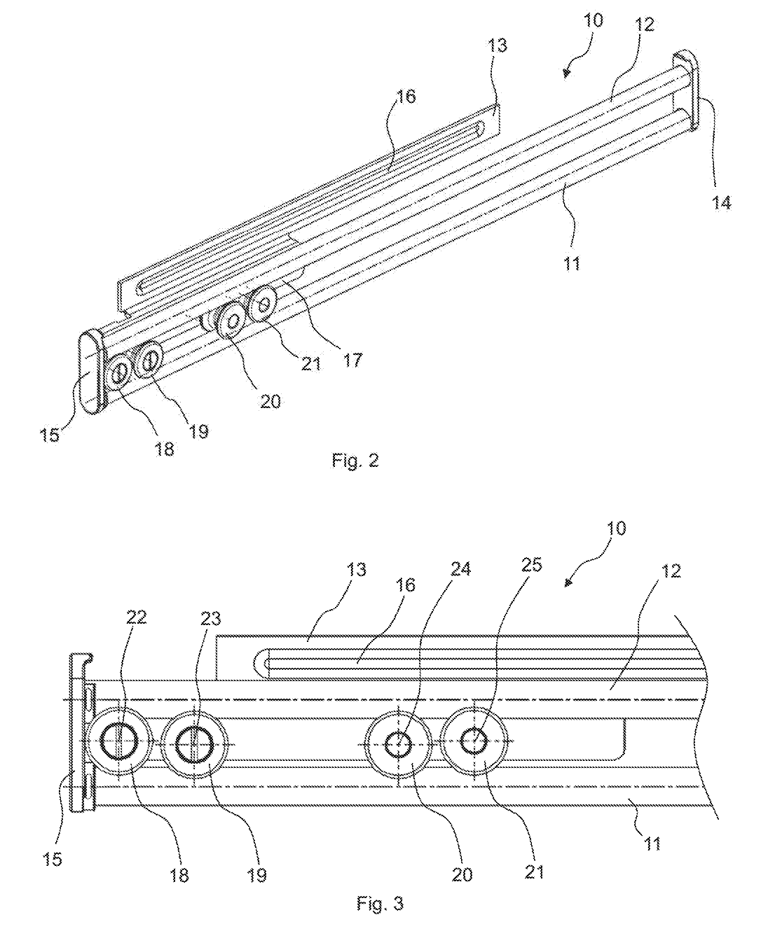

FIG. 2 shows a schematic perspective view of an embodiment of a cooking item support system for the domestic appliance in accordance with FIG. 1;

FIG. 3 shows a schematic side view of the cooking item support system in accordance with FIG. 2;

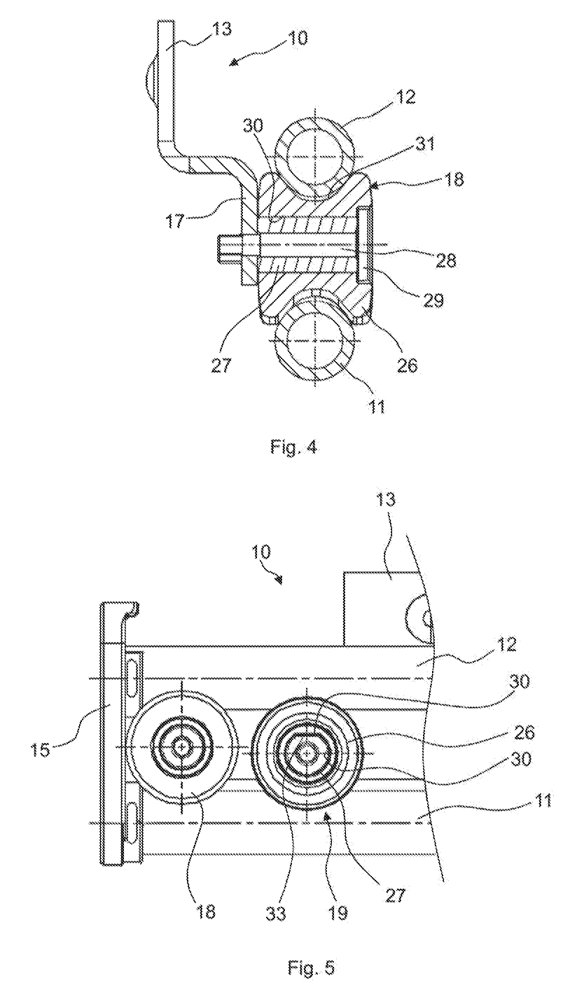

FIG. 4 shows a schematic sectional view of the cooking item support system in accordance with FIG. 2;

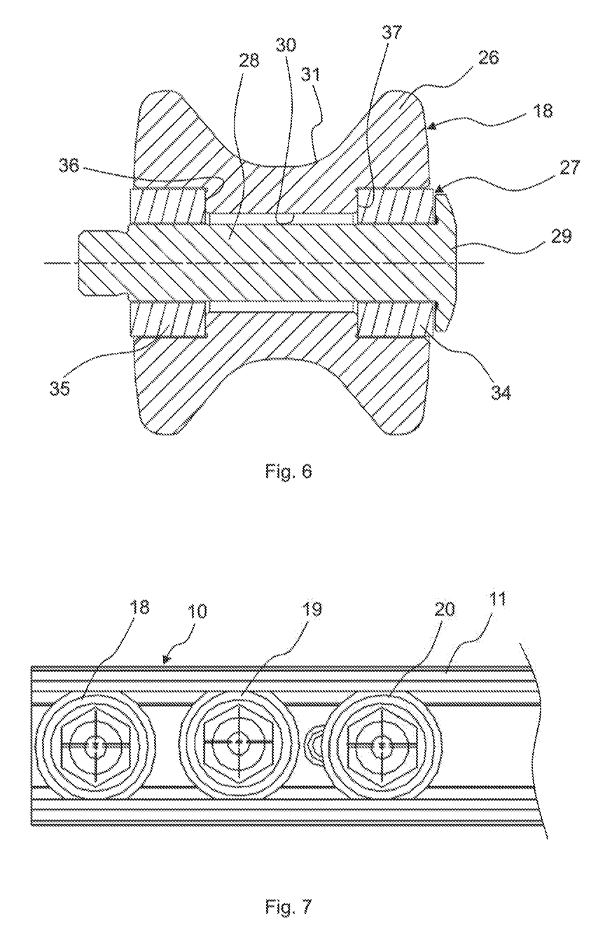

FIG. 5 shows a schematic side view of a further embodiment of a cooking item support system for the domestic appliance in accordance with FIG. 1;

FIG. 6 shows a schematic sectional view an embodiment of a roller for the cooking item support system in accordance with FIGS. 2 to 5;

FIG. 7 shows a schematic side view of a further embodiment of a cooking item support system for the domestic appliance in accordance with FIG. 1; and

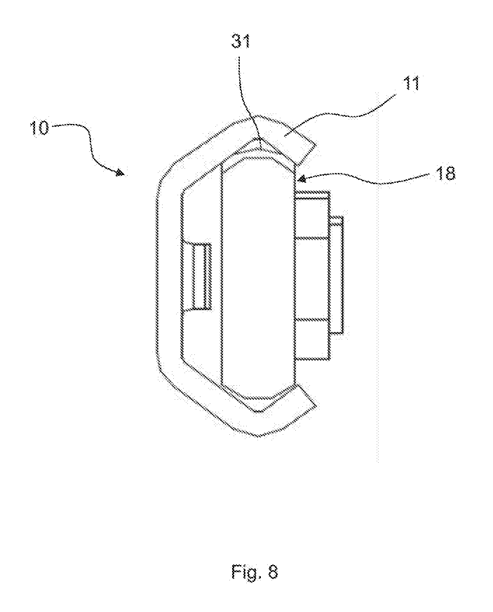

FIG. 8 shows a schematic sectional view of the cooking item support system in accordance with FIG. 7.

In the figures the same or functionally identical elements are identified by the same reference characters, unless otherwise specified.

FIG. 1 shows a schematic perspective view of a domestic cooking appliance 1. The domestic cooking appliance 1 is for example an oven, a microwave, a steam cooker, an oven having a microwave function or the like. The domestic cooking appliance 1 has a muffle or a

cooking chamber 2 which can be closed by means of a door 3. The cooking chamber 2 can be arranged in the interior of a housing of the domestic cooking appliance 1. The door 3 is illustrated in its closed position in FIG. 1. The door 3 can be closed or opened by pivoting about a pivot axis provided at a lower end of the door 3. Alternatively, the door 3 can be side-hung on the cooking chamber 2. Furthermore, the door 3 can be arranged on a baking carriage which can be withdrawn from the cooking chamber 2. A handle 4 can be provided on an upper section of the door 3.

The cooking chamber 2 has a base 5, a top 6 arranged opposite the base 5, a rear wall 7 arranged opposite the door 3 and two side walls 8, 9 arranged opposite one another. The cooking chamber 2 is preferably cuboidal or cubiform in shape. The cooking chamber 2 can be made from a metal material, in particular from sheet steel.

FIG. 2 shows a schematic perspective view of an embodiment of a cooking item support system 10 for the domestic cooking appliance 1. The cooking item support system 10 is in particular a deployment system. The deployment system can also be described as a telescopic deployment system. The cooking item support system 10 has a first running rail 11 and a second running rail 12 arranged spaced apart from the first running rail 11. The running rails 11, 12 can also be described as guide rails. The cooking item support system 10 can be fastened in releasable fashion in or on the cooking chamber 2 by means of a fastening section 13. In particular, two such cooking item support systems 10, which are preferably mounted on the opposing side walls 8, 9 of the cooking chamber 2, are provided in or on the cooking chamber. In order to clean the cooking item support system 10, for example in a dishwashing machine, the cooking item support system 10 or the cooking item support systems 10 can be removed from the cooking chamber 2.

Accessories such as for example a baking tray or a wire baking rack can be placed on the second or upper running rail 12. The running rails 11, 12 are arranged spaced apart from one another and connected to one another by means of two connection sections 14, 15. The connection sections 14, 15 are plate-shaped. A recess 16 by means of which the cooking item support system 10 can be fastened on one of the side walls 8, 9 can be provided on the fastening section 13.

The cooking item support system 10 furthermore has a support 17, to which rollers 18 to 21 are rotatably fastened. As shown in FIG. 2, four rollers 18 to 21 can be provided, in which case two rollers 18, 19 and 20, 21 respectively are arranged in pairs. The rollers 18 to 21 are designed to roll on the running rails 11, 12. The rollers 18 to 21 are rotatably mounted on the support 17. The support 17 is preferably integrally connected to the fastening section 13. The fastening section 13 and the support 17 can be a bent sheet metal component. The support 17 includes the fastening section 13. The rollers 18 to 21 are arranged between the running rails 11, 12.

As shown in FIG. 3 in a schematic side view, the rollers 18, 21 run on the second or upper running rail 12. The rollers 19, 20 run on the first or lower running rail 11. To this end, center axes 23, 24 of the rollers 19, 20 are positioned offset in respect of center axes 22, 25 of the rollers 18, 21.

FIG. 4 shows a section through the cooking item support system 10 at the level of the roller 18. As shown in FIG. 4, the running rails 11, 12 are tubular. Alternatively, the running rails 11, 12 can be of solid design. The roller 18 has a roller body 26. The roller body 26 is made from a steel material or from a ceramic material. The roller body 26 is pyrolysis-compatible. This means that the roller body will not be damaged even in the case of high temperatures, in particular in the case of temperatures in excess of 450° C.

The roller 18 furthermore has an antifriction bearing 27 accommodated at least partly in the roller body 26 for supporting the roller 18 against or on a roller pin 28 of the cooking item support system 10. The roller pin 28 is fastened to the support 17. For example, the roller pin 28 can be screwed into the support 17 or riveted to said support 17. The roller pin 28 has a disk-shaped end section 29 which prevents the roller 18 sliding off from the roller pin 28. The end section 29 completely covers the antifriction bearing 27. By this means, it is possible to conceal wear or a discoloration of the antifriction bearing 27 due to a high temperature load.

As shown in FIG. 4, the antifriction bearing 27 is implemented in a single piece in one embodiment and passes completely through the roller body 26. At the end face the end section 29 of the roller pin 28 rests against the antifriction bearing 27 and partly against the roller body 26. The antifriction bearing 27 is tubular. The antifriction bearing 27 is accommodated in a receiving section 30 of the roller body 26. The receiving section 30 can be a hole passing through the roller body 26. The antifriction bearing 27 can be connected in non-positive manner to the receiving section 30. In other words, the antifriction bearing 27 can be pressed into the receiving section 30. Alternatively or additionally, the antifriction bearing 27 can be connected in positive manner to the receiving section 30.

The antifriction bearing 27 is preferably made from a sintered metal material, a ceramic material or a graphite material. In particular, it is possible to dispense with an additional lubrication of the antifriction bearing 27. As a result, the antifriction bearing 27 retains its tribological properties even when the cooking item support system 10 is cleaned in a dishwashing machine or with the aid of pyrolysis. The antifriction bearing 27 is temperature-resistant. In particular, the antifriction bearing 27 is pyrolysis-compatible.

For example, high-density sintered materials with solid lubricants included in a bronze or iron matrix are possible materials for the antifriction bearing 27. Said materials have a good chemical resistance and a very good temperature resistance. Furthermore, different ceramic materials having excellent tribological properties, such as zirconium oxide, silicon carbide or silicon nitride can be employed for the antifriction bearing 27. In addition, special graphite can be employed as the antifriction bearing material. In addition to good mechanical properties and high temperature resistance, said material also has a good chemical resistance. Through the selection of the aforementioned antifriction bearing materials, good rolling properties or good haptics of the rollers 18 to 21 or of the cooking item support system 10 are achieved despite dispensing with lubricants. It is possible to dispense with a complex lubrication of the roller pins 28. By dispensing with the lubrication, no lubricant is able to escape between antifriction bearing 27 and roller pin 28 and contaminate the cooking item support system 10 and/or the cooking chamber 2. As shown in FIG. 4, the roller body 26 can have a concave running surface 31.

FIG. 5 shows a schematic side view of a further embodiment of a cooking item support system 10. As shown in FIG. 5, the receiving section 30 of the roller body 26 of the roller 19 comprises a counter engagement section 32, into which an engagement section 33 of the antifriction bearing 27 engages. The engagement section 33 is a lateral flattening of the antifriction bearing 27. The counter engagement section 32 of the receiving section 30 of the roller body 26 is likewise a corresponding flattening of the receiving section 30. By this means, a coding is achieved when fitting the antifriction bearing 27 into the roller body 26. Incorrect mounting of the antifriction bearing 27 is prevented. Furthermore, it is possible to dispense with a non-positive connection of the antifriction bearing 27 to the roller body 26. Excessive mechanical loading of the antifriction bearing 27 thereby causing damage to said antifriction bearing 27 is reliably prevented as a result. As a result of the coding it is possible to dispense with a high-precision fit system otherwise required between the antifriction bearing 27 and the roller body 26. This means that the cooking item support system 10 can be produced cost-effectively and simply. Such a coding can be provided on all the rollers 18 to 21.

FIG. 6 shows a schematic sectional view of a further embodiment of a roller 18. The roller 18 in accordance with FIG. 6 differs from the rollers 18 to 21 in accordance with FIGS. 2 to 5 in that the antifriction bearing 27 has two bearing elements 34, 35 which are separate from one another. At the end face the disk-shaped end section 29 of the roller pin 28 preferably rests against the bearing element 34 and prevents said bearing element 34 slipping out from the receiving section 30. Direct contact of the end section 29 with the roller body 26 is moreover also prevented by this means. The bearing elements 34, 35 can be accommodated in non-positive and/or in positive manner in the roller body 26. The bearing elements 34, 35 are accommodated at opposing end sections 36, 37 of the receiving section 30 in the latter. The end sections 36, 37 preferably have a greater diameter than a section of the receiving section 30 arranged between the end sections 36, 37.

FIG. 7 shows a schematic side view of a further embodiment of a cooking item support system 10. The cooking item support system 10 in accordance with FIG. 7 differs from the cooking item support system 10 in accordance with FIGS. 2 to 5 in that the running rail, as shown in FIG. 8, is C-shaped. For example, the cooking item support system 10 has only three rollers 18 to 20 and one running rail 11. The rollers 18 to 20 preferably have a convex or crowned running surface 31. The rollers 18, 19 run on the upper side on or in the C-shaped running rail 11 and the roller 20 runs on the lower side on or in the C-shaped running rail 11.

Although the present invention has been described with reference to exemplary embodiments, it can be modified in diverse fashion.

### LIST OF REFERENCE CHARACTERS

1 Domestic cooking appliance
2 Cooking chamber
3 Door
4 Handle
5 Base
6 Top
7 Rear wall
8 Side wall
9 Side wall
10 Cooking item support system
11 Running rail
12 Running rail
13 Fastening section
14 Connection section
15 Connection section
16 Recess
17 Support
18 Roller
19 Roller
20 Roller
21 Roller
22 Center axis
23 Center axis
24 Center axis
25 Center axis
26 Roller body
27 Antifriction bearing
28 Roller pin
29 End section
30 Receiving section
31 Running surface
32 Counter engagement section
33 Engagement section
34 Bearing element
35 Bearing element
36 End section
37 End section

1-15 (canceled)

16. A roller for a cooking item support system of a domestic cooking appliance, comprising:
a roller body; and
an antifriction bearing accommodated at least partly in the roller body and configured to support the roller against or on a roller pin of the cooking item support system.

17. The roller of claim 16, constructed for a deployment system as cooking item support system of the domestic cooking appliance.

18. The roller of claim 16, wherein the antifriction bearing is accommodated in a receiving section of the roller body.

19. The roller of claim 18, wherein the antifriction bearing is connected in non-positive manner to the receiving section.

20. The roller of claim 18, wherein the antifriction bearing is connected in a positive manner to the receiving section.

21. The roller of claim 18, wherein the antifriction bearing has an engagement section which engages in a positive manner into a counter engagement section of the receiving section.

22. The roller of claim 18, wherein the antifriction bearing has two bearing elements which are separate from one another and which are accommodated in the receiving section at opposing end sections of the receiving section.

23. The roller of claim 16, wherein the roller body is made from a steel material or a ceramic material.

24. The roller of claim 16, wherein the antifriction bearing is made from a sintered metal material, a ceramic material or a graphite material.

25. The roller of claim 16, wherein the roller body has a cylindrical, convex or concave running surface.

26. A cooking item support system for a domestic cooking appliance, comprising:
at least one running rail; and
at least one roller configured to roll on the least one running rail, said at least one roller including a roller body, and an antifriction bearing accommodated at least partly in the roller body for support of the roller.

27. The cooking item support system of claim 26, further comprising a roller pin, said at least one roller rotatably supported by the antifriction bearing against or on the roller pin.

28. The cooking item support system of claim 27, further comprising a support connectable to a side wall of a cooking chamber of the domestic cooking appliance, said roller pin being fastened to the support.

29. The cooking item support system of claim 28, constructed for removal from the cooking chamber.

30. The cooking item support system of claim 27, wherein the antifriction bearing is accommodated in a receiving section of the roller body.

31. The cooking item support system of claim 30, wherein the antifriction bearing is connected in a non-positive manner to the receiving section.

32. The cooking item support system of claim 30, wherein the antifriction bearing is connected in a positive manner to the receiving section.

33. The cooking item support system of claim 30, wherein the antifriction bearing has an engagement section which engages in positive manner into a counter engagement section of the receiving section.

34. The cooking item support system of claim 30, wherein the antifriction bearing has two bearing elements which are separate from one another and which are accommodated in the receiving section at opposing end sections of the receiving section.

35. The cooking item support system of claim 27, wherein the roller body is made from a steel material or a ceramic material.

36. The cooking item support system of claim 27, wherein the antifriction bearing is made from a sintered metal material, a ceramic material or a graphite material.

37. The cooking item support system of claim 27, wherein the roller body has a cylindrical, convex or concave running surface.

38. A domestic cooking appliance, comprising at least one member selected from the group consisting of a roller which includes a roller body, and an antifriction bearing accommodated at least partly in the roller body and configured for support of the roller, and a cooking item support system which includes at least one running rail, and the roller configured to roll on the least one running rail.

39. The domestic cooking appliance of claim 38, further comprising a cooking chamber and a second one of said cooking item support system, said two cooking item support systems being provided on opposing side walls of the cooking chamber.
